(19) United States
(12) Patent Application Publication
(10) Pub. No.: US 2016/0034058 A1
(43) Pub. Date: Feb. 4, 2016

(54) Mobile Device Input Controller For Secondary Display

(71) Applicant: Microsoft Corporation, Redmond, WA (US)

(72) Inventors: Bill Stauber, Seattle, WA (US); Ryan Pendlay, Bellevue, WA (US); Kent Shipley, Seattle, WA (US); Tim Kannapel, Seattle, WA (US); Issa Khoury, Redmond, WA (US); Petteri Mikkola, Bellevue, WA (US); Patrick Derks, Redmond, WA (US); Ramrajprabu Balasubramanian, Renton, WA (US); Keri Moran, Redmond, WA (US); Mohammed Kaleemur Rahman, Seattle, WA (US)

(21) Appl. No.: 14/447,764

(22) Filed: Jul. 31, 2014

(51) Int. Cl. G06F 3/041; G06F 3/14

(52) U.S. Cl. CPC G06F 3/041; G06F 3/1423; G06F 2203/04108

(57) ABSTRACT

Example apparatus and methods concern a first device (e.g., phone, tablet) controlling what is displayed on both the first device and on a second device (e.g., television, computer). The first device may detect the second device and establish a communication link and a context (e.g. control relationship) between the first and second device. The first device may provide an output (e.g., browser, movie) to be displayed on the second device. The first device may also provide a cursor to be displayed on the second device. In response to an action (e.g., touch, gesture) on the first device, an application running on the first device may be controlled, which may in turn determine what is displayed on the second display. The action on the first device may be related to positioning or responding to the cursor in relation to the output displayed on the second device.

### BACKGROUND

As of July 2014 there are nearly two billion smart phones in the world. There are also nearly five hundred million tablet computers in the world. Users increasingly carry their own content on their own mobile devices or access their content through their mobile devices. For example, smart phone users and tablet users may store or access movies, books, video games, and other content on their mobile device. The users of mobile devices also increasingly carry or access productivity applications, presentation applications, and other applications on their smart phone, tablet, phablet, or other mobile device. Users also increasingly perform tasks that used to be performed on larger devices (e.g., laptop computers, desktop computers) on their handheld mobile devices. For example, users browse the Internet, interact with social media, and play games on their handheld mobile devices.

Consider a couple sitting in their living room with their large screen television hanging on the wall. Perhaps the large screen television is a smart television that has a sophisticated input device (e.g., keyboard, remote control, mouse). Now imagine that the couple want to have a shared browsing experience to arrange an evening out. Conventionally, the two people may scoot together on the couch and both try to watch the small screen on the handheld mobile device or may pass the device back and forth. Some conventional attempts have been made to use the large screen television as a display for the smaller handheld device. However, these conventional attempts have been cumbersome or have provided a “heads-down” experience where the user of the hand held mobile device constantly had to shift their attention from the large display to the small display. Additionally, simple mirroring may not take advantage of the entire screen available on a television or other monitor.

Consider also a scientist travelling to a meeting. The scientist may store her slide presentation on her smart phone. While mobile devices may excel at storing or accessing content and applications on the personal scale, the display screens are typically intended for individual viewing. Thus, attempts have been made to facilitate displaying content or application output from a mobile device on a larger display. The larger display may be provided by, for example, a television, a smart television, a computer, a monitor, a projector, or other device. In these conventional approaches, two applications may have communicated to facilitate displaying content or application output and to facilitate providing a user interface for controlling the display of the content or application output.

Conventionally, it may have been difficult, if even possible at all, to provide a seamless experience for the co-operating devices. For example, a first application running on the mobile device may have provided content to a second application running on the external device (e.g., computer, smart television) and the second application may have displayed the content. The mobile device had its user interface and the external device had its user interface. Additionally, the mobile device had its input paradigm (e.g., touch screen) and the external device had its input paradigm (e.g., remote control, keyboard, mouse). While the external device may have provided a larger screen to provide a different viewing experience, the external device also provided an additional user interface and a different input paradigm to which the user may have had to conform, which typically made interactions between the devices cumbersome and complicated as users tried to reconcile interfaces and input paradigms from multiple machines. While multiple input devices and mixes and matches between input devices and systems present one type of issue, another type of issue may arise when interacting with some devices. For example, a user interacting with a projector may not have any input device able to interact with the projector.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods improve over conventional approaches by providing a more seamless “heads up” experience for users of mobile devices interacting with an external display. Rather than trying to cobble together an awkward collaboration between the two devices, which conventionally required dividing attention between two user interfaces and two input paradigms, example apparatus and methods provide a single user interface and input paradigm. For example, a “mouse pad” like experience may be provided by using the touch or hover capabilities of a user's mobile device (e.g., smart phone, tablet, phablet) as a controller for a secondary display associated with a second device. Unlike conventional systems, the user's mobile device controls what is displayed on both its display and the secondary display. The user displays information from their mobile device on a larger secondary display and interacts with the content on the secondary display using the same user interface and input paradigm that the user is familiar with on their mobile device.

Consider the couple sitting on the couch. They may be planning an evening out. One person may use their tablet computer to browse the Internet for a nearby restaurant. Information from the browsing session may be displayed on the large screen television. The person may have their tablet in their lap and may move a cursor around on the large screen television by brushing their finger back and forth on the tablet. Additionally, the person may be able to “click” on user interface controls on the displayed browser by tapping on the tablet. The couple may pick a restaurant, and may then try to get walking directions from their apartment. Thus, the person may open a mapping application. The person may zoom in and zoom out using pinch and spread gestures, either touch or hover, on the tablet in their lap. All this time the two people are able to keep their attention on the large screen television and don't have to look down at the tablet. Their shared browsing session has become a heads-up shared social session where their attention can be on the browsing and on each other, not on the device being used to do the browsing. Having the handheld mobile device enter a controller mode where it controls what is displayed on the secondary device while providing the ability to interact with the secondary device facilitates this improved experience.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example mobile device interacting with and controlling a secondary display.

FIG. 2 illustrates an example mobile device interacting with and controlling a secondary display.

FIG. 3 illustrates a secondary display that is being controlled by a single mobile device that is providing a single display.

FIG. 4 illustrates a secondary display that is being controlled by two mobile devices that are providing two displays.

FIG. 5 illustrates an example method associated with a mobile device acting as an input controller for a secondary display.

FIG. 6 illustrates an example method associated with a mobile device acting as an input controller for a secondary display.

FIG. 7 illustrates an example cloud operating environment in which a mobile device may act as an input controller for a secondary display.

FIG. 8 is a system diagram depicting an exemplary mobile communication device that may act as an input controller for a secondary display.

FIG. 9 illustrates an example apparatus that provides touch and hover-sensitive control of a secondary display.

### DETAILED DESCRIPTION

As devices like phones and tablets become even more ubiquitous, users' expectations about the functions that ought to be performed by their “phone” have risen dramatically. However, mobile devices that have been used as controllers for secondary displays have typically produced a heads-down experience where it has been difficult, if even possible at all, to work seamlessly with what is displayed on the secondary display. The heads-down experience results from having to look down at the phone or tablet to make sure that the user is touching the “right” location. The “right” location has typically been defined or controlled by the secondary device (e.g., computer, television) providing the secondary display. Example apparatus and methods detect actions (e.g., touch actions, hover actions) performed at an i/o interface on the user's mobile device (e.g., phone, tablet) and control displays and interactions with a secondary display in a “heads-up” experience where the first device controls what is displayed on both devices.

Example apparatus and methods may display user interface elements (e.g., cursors, dialog boxes, scroll bars, virtual keyboards) on the secondary display. Unlike conventional systems that tightly couple user interface elements on the user's mobile device with the user interface elements on the secondary display, example apparatus and methods may decouple or at least less tightly couple the user interface elements to produce the heads-up experience. A touch or hover point (reference point) may be established with respect to a digit (e.g., thumb) in a touch or hover space associated with a user's touch or hover sensitive device (e.g., phone, tablet). The reference point may be used to control the presence, location, appearance, or function of a cursor displayed on the secondary display. For example, as the user moves their thumb in x, y, or z directions in the touch or hover space, the cursor may move around on the secondary display. In one embodiment, the surface of the user's device may be mapped to the surface of the secondary display. But in another embodiment, the surface of the user's device may not be mapped to the surface of the secondary display and the touch or hover movements may position the cursor independent of where in the touch or hover space the reference point is located. The touch or hover movements may cause inputs similar to those that would be provided by a mouse pad. While the term “cursor” is used to refer to the item being presented on the secondary display, more generally, a touch or hover point or other visual indicia may be presented on the secondary display to indicate the point being controlled on the secondary display by the touch or hover point.

Users are familiar with remote controls for their own television, their own DVD (digital versatile disk) player, their own game console, and other devices with which they interact regularly. These remote controls tend to have fixed physical buttons mapped to pre-defined control actions. For example, the on/off button on a television remote control may always be in the same location and may always perform the same function. Similarly, the “right trigger” and “left trigger” buttons on a game controller may always be in the same location and may always be mapped to the same control action for an application (e.g., game). Conventional device controllers (e.g., game controllers, keyboards, game controls) have had physical buttons that provided a user with physical touch points that helped a user make a desired input without having to look down at their own controller. Using these conventional controllers may become second nature to their owners, but these same controllers may be completely alien to anyone but their owners. Many people are familiar with the mystifying and frustrating experience of trying to figure out how to turn on the television at someone else's house.

The prevalence of touch sensitive devices (e.g., smart phones, tablets) has added yet another piece of electronics equipment to the user's already-crowded daily life. Attempts have been made to replace conventional, dedicated, button-centric controllers with touch sensitive devices. However, smart phones, tablets, and other touch or hover sensitive devices do not have the familiar buttons at the familiar locations and therefore have not yielded acceptable results. Conventional attempts to use touch or hover sensitive devices having their own displays have followed a model where the controls for the secondary device are displayed on the touch or hover sensitive device. For example, for a DVD player control, the phone may display DVD controls on the phone. This results in a “heads-down” operation where the user's focus is directed towards the hand held touch or hover sensitive device rather than a secondary display. Even when corresponding controls are displayed on both a secondary display and a touch or hover sensitive device, the corresponding controls tend to be tightly coupled between the handheld device and the secondary display and thus the user tends to switch their focus to the hand held device to make sure they are pressing the desired button. Even when a useable pairing between a handheld device and an external display is made, the user may still have to navigate the user interface that is native to the external device. For example, different smart TVs may have different input interfaces, devices, or paradigms. These user interfaces or devices may not be familiar to the user and may be different for every external device that the user encounters with their mobile device. The user still has to learn the interface to the native controller, rather than just using their own device.

By not directly mapping locations on the user's device to the secondary display, example apparatus and methods may allow the user's device to act more like a controller and less like a miniature version of the secondary display. In one embodiment, a cursor may initially be positioned in the center of the secondary display regardless of where the reference point is established on the mobile device. Since the user knows that the cursor will appear in the middle of the secondary display no matter where they establish the reference point on their mobile device, there is no incentive for the user to look at their device. In another embodiment, the cursor may be positioned over a most-likely to be used control on the secondary display regardless of where the reference point is established on the user's device. Again, because the user knows that the cursor will appear in a pre-defined position that is independent of where the reference point is established on the user's device, there is no incentive to look down at their device, which promotes the heads-up experience. In one embodiment, the cursor may initially be placed based on the mapped location of the reference point. As the user moves their thumb around in the touch or hover space associated with their mobile device the cursor may move on the secondary display. Ultimately, the user may decide to “press” a button on the secondary display by tapping on their device after positioning the cursor over the button. It may not matter where on their device the user taps, it may only matter that the user tapped the device while it was providing the cursor and the content to the secondary display.

Consider a scenario where a user has a phone with the ability to “screencast” a screen to a secondary screen. For example, the phone may be able to Miracast to the secondary screen. The secondary screen may have been launched by their phone or by another device or process. Example apparatus and methods provide the phone with the ability to control output (e.g., content, cursor) on the secondary screen using a touch or hover functionality provided by their phone. The touch or hover functionality may allow a user to run a game on their phone, display the game on the secondary display, and use the phone as a controller for the game. The control provided by the phone may allow a game control or system level control to be displayed on the game on the secondary display. Other applications (e.g., browsers) may also be displayed, interacted with, and controlled.

Example apparatus and methods provide this improved seamless experience by having the mobile device control what is shown on both its display and the display of the external device. For example, when the user's device is interacting with an external display as supported by example apparatus and methods, the user's device may provide both the user interface and the content for the external display. The user interface may include both controls (e.g., buttons, scroll bars, menus) and a moveable cursor for interacting with the controls or the content. The content may be, for example, a slide show, a movie, a photograph, a video game, or output from another application. Unlike conventional systems, the mobile device controls what is shown on both devices.

Once the content from the user device is displayed on the external device, the user may wish to have a “heads up” experience where they can keep their focus on the display on the external device. Example apparatus and methods therefore facilitate using the mobile device as an input device for the external display using the user interface and input paradigm that are native to the mobile device. For example, touches or gestures made at the mobile device may control (e.g., reposition) a cursor on the external device. Similarly, touches or gestures (e.g., scroll, click, zoom in, zoom out) made at the mobile device may control the display of content on the external device.

Consider again the couple having the shared browsing experience on their couch in front of their large screen smart television. The tablet may be used to provide a mouse pad-like experience for the couple. They may be able to reposition a cursor, scroll through images, pull down menus and make selections, enter text, or perform other user input actions through the tablet while maintaining their focus on the large screen television. For example, when making a reservation at the restaurant they selected, a dialog box may appear in the browser. The dialog box may seek a name for the reservation. In this example, the couple's tablet may display a virtual keyboard on the secondary display to allow typing in the name using the tablet computer. The virtual keyboard may be provided by and handled by the tablet. After the name is entered, the reservation may request a time to be entered. A spinner input that lets a user spin dials for the hour and minute of the reservation time may be presented. The user may be able to spin the dials using scrolling or brushing gestures on the tablet, and then may click on a submit button by tapping on the controller. The spinner may be provided by the tablet. The couple may even be able to hand the tablet back and forth during their shared browsing experience.

Consider again the scientist who is displaying her slide show at the conference. She may place her smart phone on the table in front of her and use it as a mouse pad-like input device with respect to the displayed slide show. The scientist may use the same touches or gestures she would use with the smartphone to manipulate a cursor or content on the external display. The seamless heads up experience is achieved by having the smart phone control what is displayed on both devices, even when the external device has its own processor, memory, or other resources. When the smart phone is interacting with the external display, the smart phone may decide to no longer display the slide show on its own display.

Some embodiments may include a capacitive input/output (i/o) interface that is sensitive to both touch and hover actions. The capacitive i/o interface may detect objects (e.g., finger, thumb, stylus) that touch the screen. The capacitive i/o interface may also detect objects (e.g., finger, thumb, stylus) that are not touching the screen but that are located in a three dimensional volume (e.g., hover space) associated with the screen. The capacitive i/o interface may be able to simultaneously detect a touch action and a hover action. The capacitive i/o interface may be able to detect multiple simultaneous touch actions and multiple simultaneous hover actions. A first device (e.g., phone) may establish a context with which the first device will interact with a secondary device (e.g., television, computer monitor, game monitor). The first device may enter a controller mode where the first device becomes responsible for what is displayed on both devices. The first device may provide a hover interface that facilitates moving a cursor on the secondary device. The first device may control what is displayed on both the first device and the second device.

While a single user with a single phone has been described so far, example apparatus and methods may provide hover or touch points on a secondary display for multiple users or multiple phones that are sharing a single secondary display or even multiple presentations on a secondary display. For example, two users who are playing a football game may each be provided with a cursor that can be used to control players displayed on the secondary display. Or, multiple users who are collaborating in a team-oriented video game may each have a cursor displayed on a community secondary display to facilitate interacting with virtual controls and with each other. Returning to our couple on the couch, both people may have their tablets. One tablet may become the “primary” controller and may present, for example, a browser on the large screen television. The holder of this tablet may be presented with a first cursor on the browser. The other tablet may become the “secondary” controller and may present the holder of the second tablet with a second cursor on the browser. Thus, both users may be able to navigate on the large screen television at the same time.

In one embodiment, a portion of the real estate on the large screen television may be allocated to the first user and a different portion of the real estate on the large screen television may be allocated to the second user. In this embodiment, the first user's tablet may control what is displayed on the first portion of the large screen and the second user's tablet may control what is displayed on the second portion of the large screen. For example, the first user may have a browser session open in which the couple is locating restaurants. The second user may have a social media application open that the couple is using to co-ordinate the restaurant visit with a friend. The first user's mobile device may provide a cursor and other user interface functionality for the browser while the second user's mobile device may provide a different cursor and other user interface functionality for the social media application. In this embodiment, the couple enjoys a dual heads-up shared browsing experience that is unavailable in conventional systems.

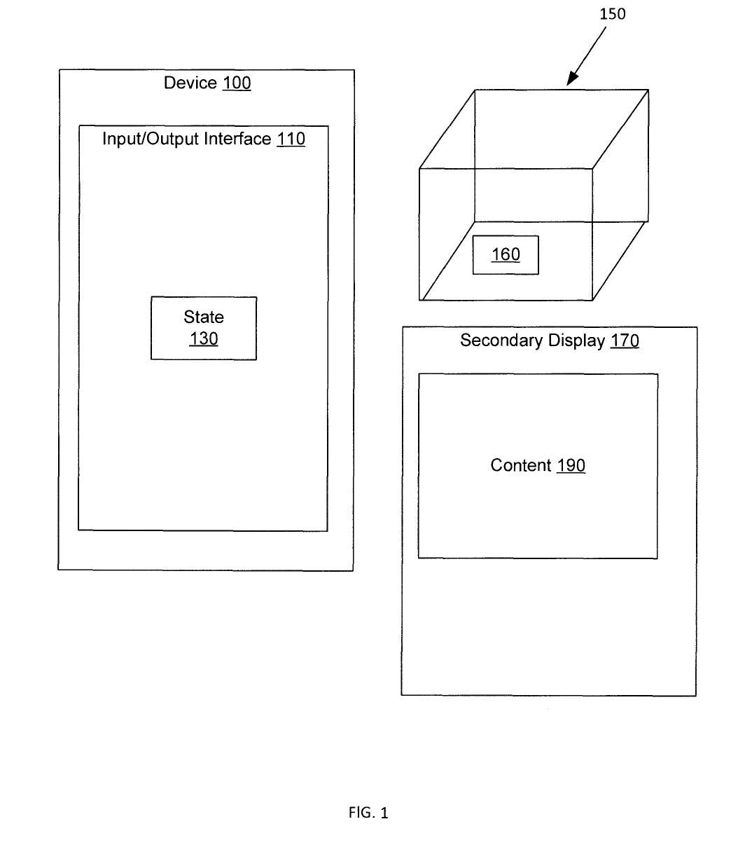

FIG. 1 illustrates an example device 100 that may be both touch-sensitive and hover-sensitive. Device 100 includes an input/output (i/o) interface 110. I/O interface 110 may be both touch-sensitive and hover-sensitive. Example device 100 controls what is displayed on both the example device 100 and on a secondary display 170. The device 100 may include a touch detector that detects when an object (e.g., digit, pencil stylus with capacitive tip) is touching the i/o interface 110. The touch detector may report on the location (x, y) of an object that touches the i/o interface 110, the location of a cursor on secondary display 170, a user interface element that was activated on secondary display 170, or other information. The touch detector may also report on a direction in which the object is moving, a velocity at which the object is moving, whether the object performed a tap, double tap, triple tap or other tap action, whether the object performed a recognizable gesture, or other information.

The device 100 may also include a proximity detector that detects when an object (e.g., digit, pencil, stylus with capacitive tip) is close to but not touching the i/o interface 110. The proximity detector may identify the location (x, y, z) of an object 160 in the three-dimensional hover space 150, where x and y are orthogonal to each other and in a plane parallel to the surface of the interface 110 and z is perpendicular to the surface of interface 110. The proximity detector may also identify other attributes of the object 160 including, for example, the speed with which the object 160 is moving in the hover space 150, the orientation (e.g., pitch, roll, yaw) of the object 160 with respect to the hover space 150, the direction in which the object 160 is moving with respect to the hover space 150 or device 100, a gesture being made by the object 160, or other attributes of the object 160. While a single object 160 is illustrated, the proximity detector may detect more than one object in the hover space 150.

In different examples, the touch detector may use active or passive systems. Similarly, in different examples, the proximity detector may use active or passive systems. In one embodiment, a single apparatus may perform both the touch detector and proximity detector functions. The combined detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the combined detector uses capacitive technology, the detector may include a set of capacitive sensing nodes to detect a capacitance change in the hover space 150 or on the i/o interface 110. The capacitance change may be causec, for example, by a digit(s) (e.g., finger, thumb) or other object(s) (e.g., pen, capacitive stylus) that touch the capacitive sensing nodes or that come within the detection range of the capacitive sensing nodes.

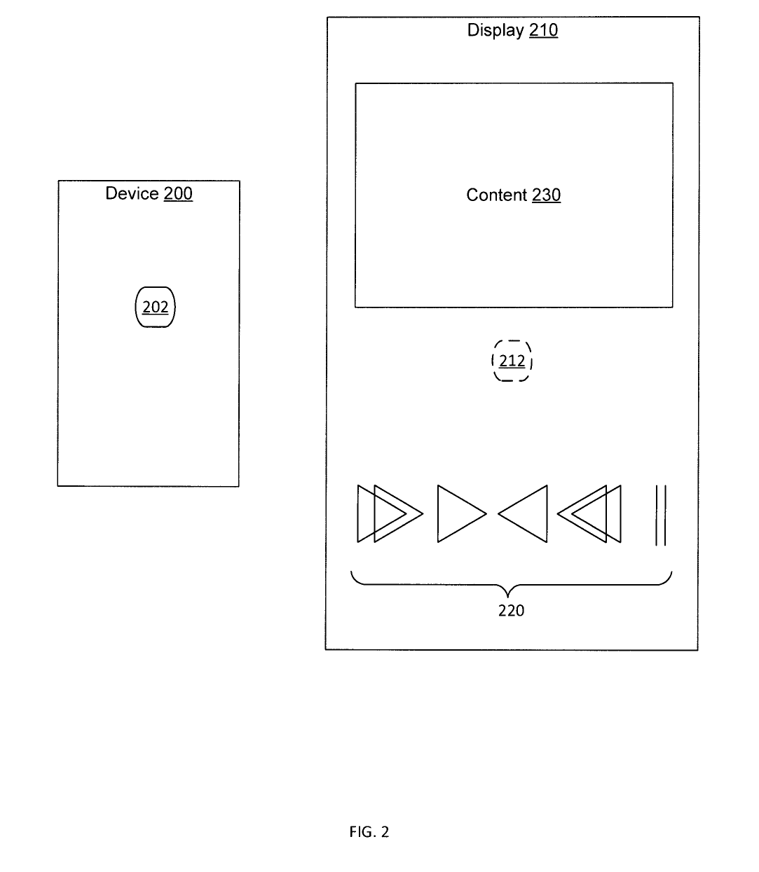

FIG. 2 illustrates a touch or hover sensitive device 200 (e.g., phone, tablet) interacting with a secondary display 210 (e.g., television). Device 200 may establish a communication link with the secondary display 210. Once communications have been established and device 200 enters a controller mode, then device 200 controls what is displayed on both device 200 and secondary display 210. For example, a set of controls 220 may be displayed on the secondary display 210 and a dotted circle 212 may be displayed on the secondary display 210 as a cursor or as a representation of the location of the user's digit. In one embodiment, the set of controls 220 may also be displayed on device 200. Which controls 220 are displayed may depend on the application running on device 200 that is providing content 230 (e.g., movie, document, game) to display 210. The size, shape, appearance, or other attributes of the cursor 212 may also depend on the application. A user may then move the touch or hover point 202 to reposition the cursor 212. If the user positions the cursor 212 over a member of the controls 220 and then interacts with device 200, it may appear that the member of the controls 220 was pressed and a corresponding action associated with the member of the controls 220 may be generated. For example, pressing a pause button may pause the presentation of the content 230. The action may control the application that is providing the content to the display 210. In a conventional system, the controls displayed on secondary display 210 are provided by the secondary device and thus the user may need to conform their actions to the secondary device. Example apparatus cause controls displayed on secondary display 210 to be provided by apparatus 200, and thus the user may interact with the apparatus 200 and the secondary display 210 using actions with which they are familiar.

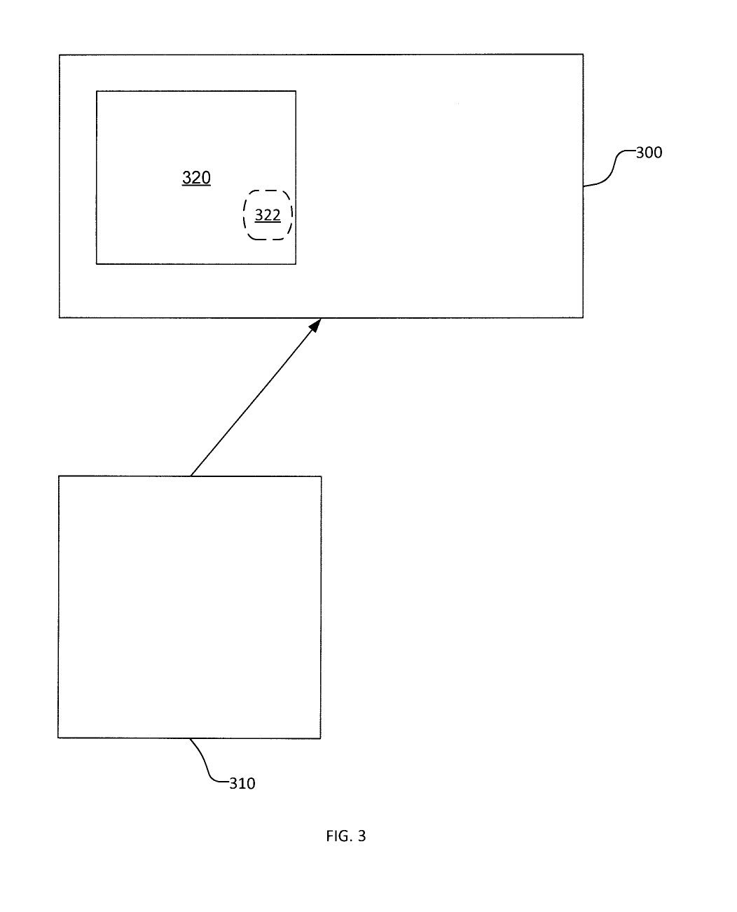

FIG. 3 illustrates a secondary display 300 that is being controlled by a single mobile device 310 that is providing a single display 320 on the secondary display 300. The single display 320 may be, for example, a browser that is running on mobile device 310. Mobile device 310 may provide both the display 320 and a cursor 322. The cursor 322 may be controlled by user actions (e.g., taps, scrolls, gestures) performed on the mobile device 310.

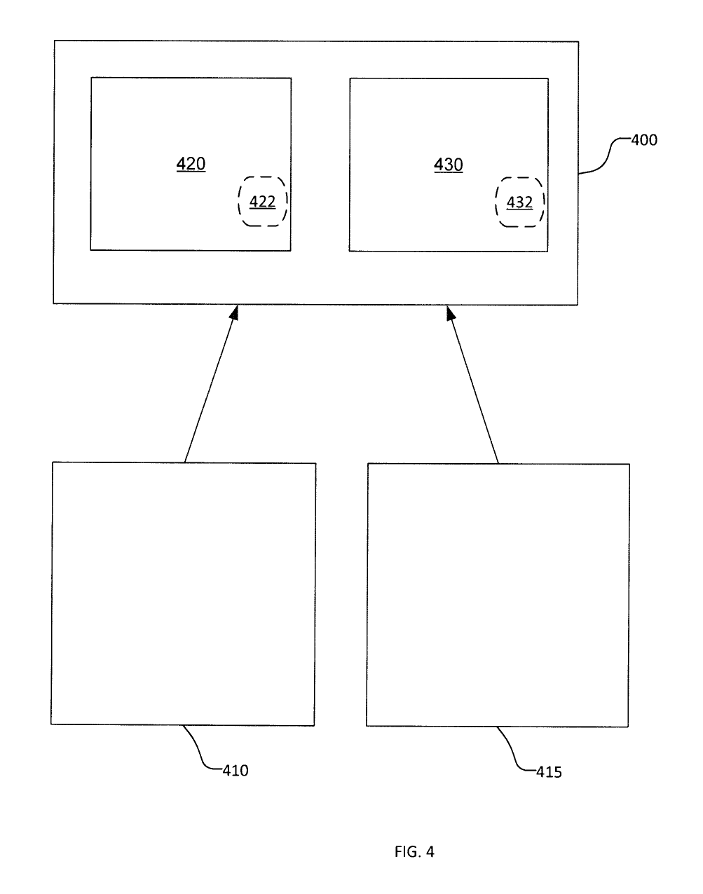

FIG. 4 illustrates a secondary display 400 that is being controlled by two mobile devices that are providing two displays. In one embodiment, the two mobile devices may be sharing the same large display. A first mobile device 410 may be providing a first display 420 and a first cursor 422. First cursor 422 may be controlled by actions (e.g., touches, hover gestures) performed on mobile device 410. A second mobile device 415 may be providing a second display 430 and a second cursor 432. Second cursor 432 may be controlled by actions (e.g., touches, hover gestures) performed on mobile device 415. Returning to the couple described above, a first person may be holding device 410 (e.g., smart phone) and browsing the internet and a second person may be holding device 415 (e.g., tablet) and may be interacting with a social media application.

While two mobile devices are illustrated providing two displays and two cursors, different numbers and combinations of mobile devices may provide different numbers and combinations of displays and cursors.

The functionality described in connection with FIGS. 3 and 4 may be provided by a system. In one embodiment, the system may include a first mobile device running a first application, a second mobile device, and an apparatus having a display that is external to and disjoint from the first mobile device and the second mobile device. In this embodiment, the first mobile device controls images displayed on the first mobile device and the display. The images are associated with the first application. For example, the application may be a browser and the images may be the screens produced by the browser.

In this embodiment, the first mobile device also provides cursors. For example, the first mobile device may provide a first movable cursor for the first mobile device and a second movable cursor for the second mobile device. The first movable cursor is movable on the display in response to actions performed at the first movable device. For example, as a user moves their finger around on the first device the first cursor may also move around. Similarly, the second movable cursor is movable on the display in response to actions performed at the second movable device. In this embodiment, the first mobile device may perform all the control. Thus, the first mobile device may handle user inputs at the first mobile device related to the first cursor and the first application may also handle user inputs at the second mobile device related to the second cursor and the first application.

In another embodiment, the second device may also run an application. In this embodiment, the first mobile device may still exercise almost all the control in the system. For example, the first mobile device may control images displayed on the display, where the images are associated with the first application or the second application. Additionally, the first mobile device may handle user inputs at the first mobile device related to the first cursor and the first application and may also handle user inputs at the second mobile device related to the second cursor and the second application.

In another embodiment, the control may be more distributed. For example, the second mobile device may run a second application. In this embodiment, the first mobile device may control images associated with the first application presented on the display but the second mobile device may control images associated with the second application presented on the display. Continuing the theme of distributed control, the first mobile device may handle user inputs at the first mobile device related to the first cursor and the first application and the second mobile device may handle user inputs at the second mobile device related to the second cursor and the second application.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

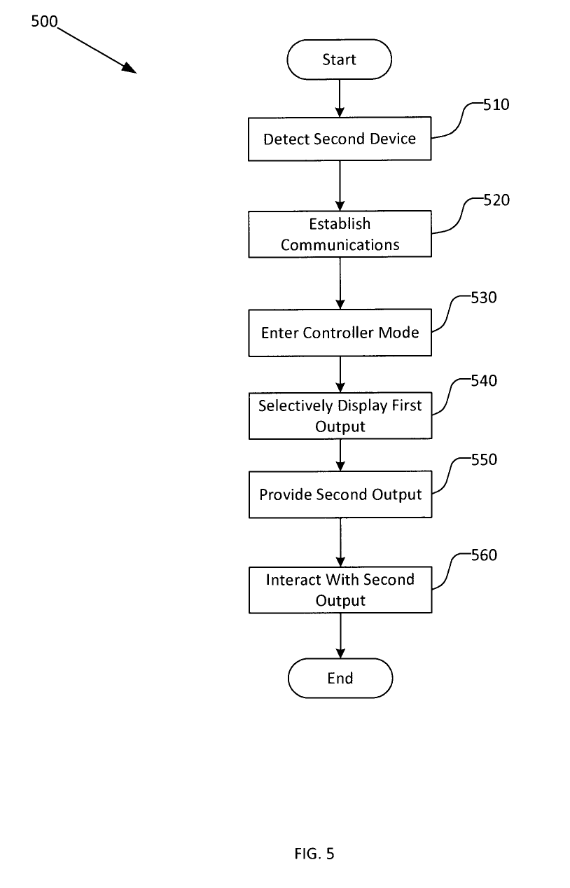

FIG. 5 illustrates an example method 500 associated with a mobile device acting as a controller for a secondary display. Method 500 may run on a first device (e.g., phone, tablet, computer) having a hover-sensitive or touch-sensitive interface and a display. Method 500 may control the first device to provide content, cursors, controls, or other information to a display on a second device. Thus, method 500 includes, at, 510, detecting a second device having a second display. The second device may be, for example, a television, a monitor, a computer, a projector, a dongle that may be plugged into an output device, or other device.

Method 500 includes, at 520, establishing a communication link between the first device and the second device. Establishing the communication link may include, for example, establishing a wired link or a wireless link. The wired link may be established using, for example, an HDMI (high definition multimedia interface) interface, a USB (universal serial bus) interface, or other interface. The wireless link may be established using, for example, a Miracast interface, a Bluetooth interface, an NFC (near field communication) interface, or other interface. A Miracast interface facilitates establishing a peer-to-peer wireless screencasting connection using WiFi direct connections. A Bluetooth interface facilitates exchanging data over short distances using short-wavelength microwave transmission in the ISM (Industrial, Scientific, Medical) band.

Method 500 also includes, at 530, entering a controller mode. Entering the controller mode may be part of establishing a context for an interaction between the first device and the second device. In the “controller” mode, the first device will control what is displayed on both the first device and the second display. In one embodiment, establishing the context includes identifying the application that will produce content to be displayed on the second display. The application may be, for example, a browser, a social media application, a movie presentation application, a television presentation application, a video game, a productivity application, a slide show application, or other application that produces content that can be viewed. The application will run on the first device or will be facilitated by the first device.

Establishing the context may also include identifying a user interface element that may be displayed on the second display by the first device. Certain user interface elements make sense for certain applications. For example, DVD-like controls make sense for a movie or television presentation application, but may not make sense for a video game. User interface elements that facilitate moving a character around a virtual world may be more appropriate for a video game. When a browser is presented for a shared browsing experience, the only user interface element that may need to be displayed initially is a cursor. In one embodiment, the user interface elements presented could include “browser chrome” including, for example, an address bar, a back button, a forward button, a refresh button, or other elements. In one embodiment, when multiple first devices are being used, one cursor may be provided for one mobile handheld device (e.g., user's smart phone) and another cursor may be provided for another mobile handheld device (e.g., user's tablet).

Establishing the context may also include identifying a cursor that may be displayed on the second display by the first device. Different cursors may be appropriate for different applications. For example, a crosshairs may be appropriate for an application where targeting is involved but a pair of scissors or paint brush may be appropriate for an arts and crafts application. When multiple first devices are being used, a user's initials or avatar may be employed as a cursor.

In one embodiment, establishing the context may also include identifying whether a cursor location or movement will be independent of a location of the touch or hover point. Unlike conventional applications that map locations on a touch-sensitive device directly to locations on a secondary display, and that map controls displayed on the first device to controls displayed on the secondary display, method 500 may decouple the one-to-one correspondence to allow the touch or hover-sensitive device to produce motion that does not depend on a position over the user's mobile device but rather on a motion over the mobile device. Users are familiar with mouse pad like motion or trackball like motion and with motion where, for example, a mouse is moved left to right, picked up and moved back to the left, placed down and moved left to right again, and so on. These types of motions have typically been difficult, if even possible at all, to capture or model with mobile devices being used in a conventional heads-down approach where mobile device screen locations were mapped directly to secondary display locations that corresponded to controls provided by the secondary display.

Method 500 also includes, at 540, selectively displaying, on the first display, a first output associated with an application running on the first device. The application may be, for example, a web browser. The output may be, for example, the web browser. In one embodiment, to promote the heads-up experience, once the first device enters the controller mode, method 500 may cause the first display to go dark, or to only display information useful for moving a cursor.

Method 500 also includes, at 550, providing a second output to be displayed on the second display. The second output may be associated with an application (e.g., browser) or content (e.g. movie) from an application associated with the first device. For example, for a movie application, the second output is the movie (e.g., stream of scenes) while for a video game the second output is the game screen and for a word processing application the second output is the document being word processed. For a browser, the second output may be the browser. In one embodiment, the application may be running on the first device. In another embodiment, the application may be running on a third device or in the cloud and the content may be streamed through the first device. The second output may be the same as the first output.

Method 500 also includes, at 560, using the touch or hover interface to interact with the second output. In one embodiment, using the touch or hover interface to interact with the second output includes selectively controlling the application, the first output, or the second output. The control may be based, at least in part, on a touch or hover action performed with the touch or hover interface. For example, if the touch action is a tap on a link displayed in the browser, then the link may be followed. Since the first device is displaying content on the second device, the touch or hover action may be related to the second output that is being displayed on the second display. For example, if the touch action is a spread gesture, then the second output may be zoomed out. The touch or hover action may be, for example, a tap or double tap. The touch or hover action may also be, for example, a gesture (e.g., pinch, spread, crane, toss).

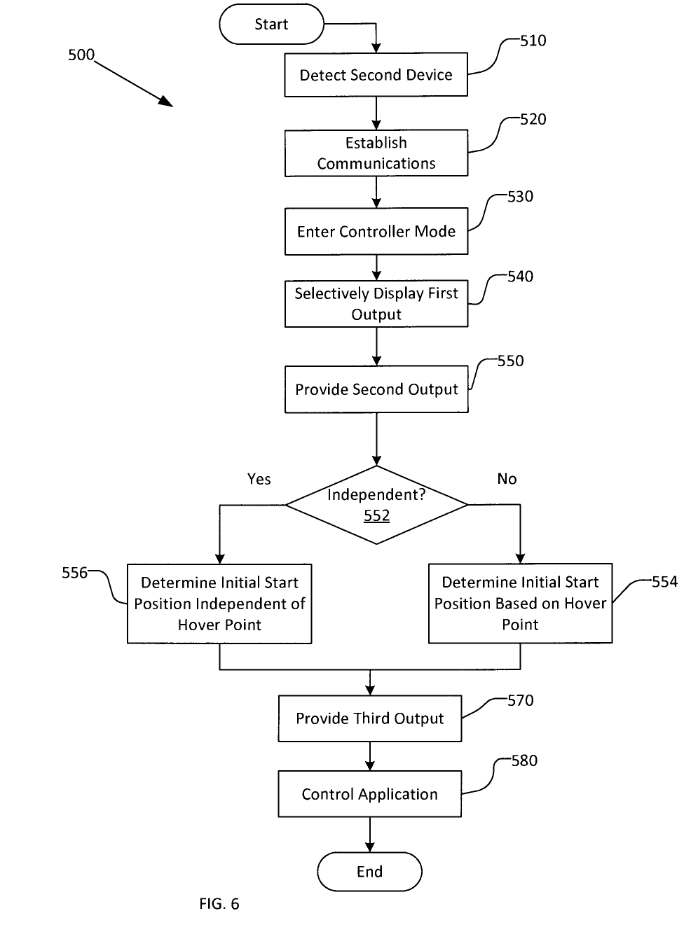

FIG. 6 illustrates another embodiment of method 500. This embodiment also includes additional actions. For example, this embodiment includes, at 570, providing a third output to be displayed on the second display. The third output may include a user interface element configured to facilitate interacting with the second output. The third output may be, for example, a cursor. The third output may be associated with controlling the application. The third output may be movable on the second display in response to touch or hover actions performed with the touch or hover interface. For example, as a user scrolls their finger left to right on their smart phone the cursor displayed on the large screen television may also be moved from left to right.

This embodiment of method 500 also includes, at 580, selectively controlling the application, the first output, the second output, or the third output based, at least in part, on a touch or hover action performed with the touch or hover interface, where the touch or hover action is related to the second output. The touch or hover action may be related to the second output by the position of the cursor. Controlling the application may include providing a control event to the application. For example, a tap on the first device when the cursor is positioned over a button may cause a button-click event to be provided to the application. Controlling the second output may include, for example, zooming in or zooming out in response to, for example, a pinch or spread gesture. Controlling the third output may include, for example, changing the cursor from an icon associated with an inactive cursor to an icon associated with an active cursor.

In one embodiment, the third output may be context sensitive. For example, the third output may include DVD-like controls and a cursor that can be positioned over or near one of the DVD-like controls. Characteristics of the third output may be based, at least in part, on the context and on a hover action associated with a hover point. For example, the size, shape, color, or other appearance of the second output may be based on which application is running and what type of hover action occurred. On a hover enter event, where a hover point is first established, a large, dim cursor may be established on the secondary display. On a hover move event that brings the hover point closer to the hover-sensitive device, a smaller, brighter cursor may be presented on the secondary display. Thus, method 500 may include controlling an appearance (e.g., size, shape, color) of a cursor based on the z-distance of the hover point (e.g., distance of object generating hover event from hover-sensitive interface). Recall that the second output may be content from the application (e.g., movie, game screen, document being edited) or may be a representation of an application (e.g., browser) and that the third output is not content from the application. The third output may facilitate working with or manipulating the application or the second output.

This embodiment of method 500 may also include, at 552, determining whether an attribute of the cursor will be independent of a location of a touch or hover point associated with the touch or hover interface. The attribute may be, for example, the location of the cursor, the appearance of the cursor, how the cursor will move, or other attributes. If the determination at 552 is yes, then method 500 proceeds, at 556, to determine the attribute independent of the position of the touch or hover point. For example, the initial location may be in the center of the secondary display, on or near the most likely to be used control, equidistant between two controls, centered in a group of controls, or in another location that does not depend on the location of the hover point. When the location of the cursor does not depend on the position of the touch or hover point, there is no reason to look down at the touch or hover sensitive device, which promotes heads-up operation. If the determination at 552 is no, then method 500 proceeds, at 554, to determine the attribute of the cursor based on the touch or hover point.

While FIGS. 5 and 6 illustrate various actions occurring in serial, it is to be appreciated that various actions illustrated in FIGS. 5 and 6 could occur substantially in parallel. By way of illustration, a first process could control content to be displayed, a second process could control cursors and controls to be displayed, and a third process could generate or handle control events. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer, phone, tablet) cause the machine to perform methods described or claimed herein including methods 500 or 600. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

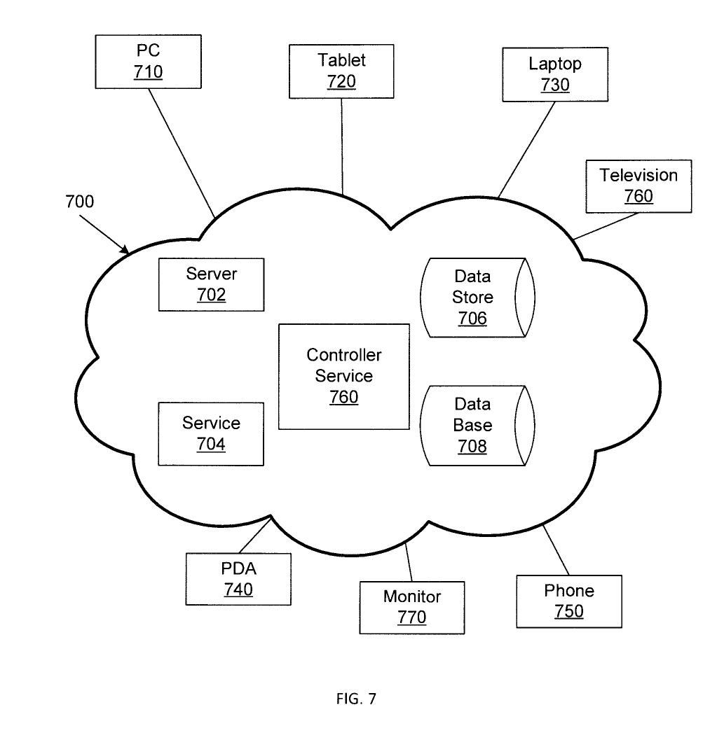

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example controller service 760 residing in the cloud 700. The controller service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud 700 and may, therefore, be used by the controller service 760.

FIG. 7 illustrates various devices accessing the controller service 760 in the cloud 700. The devices include a computer 710, a tablet 720, a laptop computer 730, a desktop monitor 770, a television 760, a personal digital assistant 740, and a mobile device (e.g., cellular phone, satellite phone) 750. It is possible that different users at different locations using different devices may access the controller service 760 through different networks or interfaces. In one example, the controller service 760 may be accessed by a mobile device 750. In another example, portions of controller service 760 may reside on a mobile device 750. Controller service 760 may perform actions including, for example, presenting content on a secondary display, presenting an application (e.g., browser) on a secondary display, presenting a cursor on a secondary display, presenting controls on a secondary display, generating a control event in response to an interaction on the mobile device 750, or other service. In one embodiment, controller service 760 may perform portions of methods described herein (e.g., method 500, method 600).

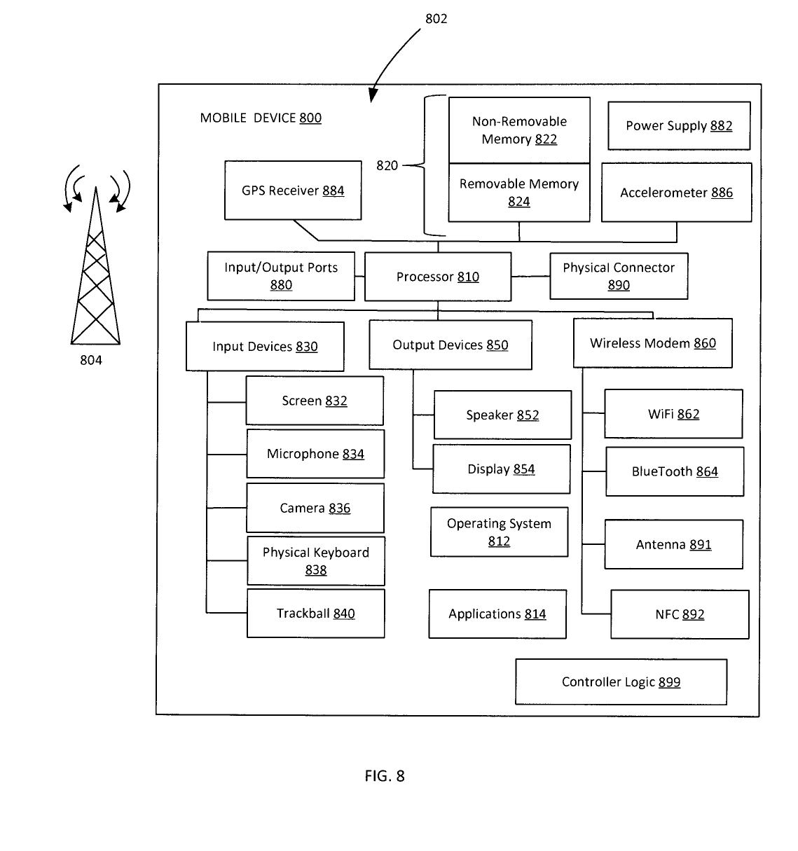

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, tablet, phablet, handheld computer, Personal Digital Assistant (PDA), etc.) and may allow wireless two-way communications with one or more mobile communications networks 804, such as a cellular or satellite networks.

Mobile device 800 can include a controller or processor 810 (e.g., signal processor, microprocessor, application specific integrated circuit (ASIC), or other control and processing logic circuitry) for performing tasks including touch detection, hover detection, hover point control on a secondary display, touch point control on a secondary display, user interface display control on a secondary device, signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), video games, movie players, television players, productivity applications, or other applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards.” The memory 820 can be used for storing data or code for running the operating system 812 and the applications 814. Example data can include touch action data, hover action data, combination touch and hover action data, user interface element state, cursor data, hover control data, hover action data, control event data, web pages, text, images, sound files, video data, or other data sets to be sent to or received from one or more network servers or other devices via one or more wired or wireless networks. The memory 820 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a screen 832 that is both touch and hover-sensitive, a microphone 834, a camera 836, a physical keyboard 838, or trackball 840. The mobile device 800 may also support output devices 850 including, but not limited to, a speaker 852 and a display 854. Display 854 may be incorporated into a touch-sensitive and hover-sensitive i/o interface. Other possible input devices (not shown) include accelerometers (e.g., one dimensional, two dimensional, three dimensional). Other possible output devices (not shown) can include piezoelectric or other haptic output devices. Some devices can serve more than one input/output function. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting touch and hover gestures associated with controlling output actions on a secondary display.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices that have secondary displays whose content or control elements may be controlled, at least in part, by controller logic 899. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a controller logic 899 that provides a functionality for the mobile device 800 and for controlling content or controls displayed on a secondary display with which mobile device 800 is interacting. For example, controller logic 899 may provide a client for interacting with a service (e.g., service 760, FIG. 7). Portions of the example methods described herein may be performed by controller logic 899. Similarly, controller logic 899 may implement portions of apparatus described herein.

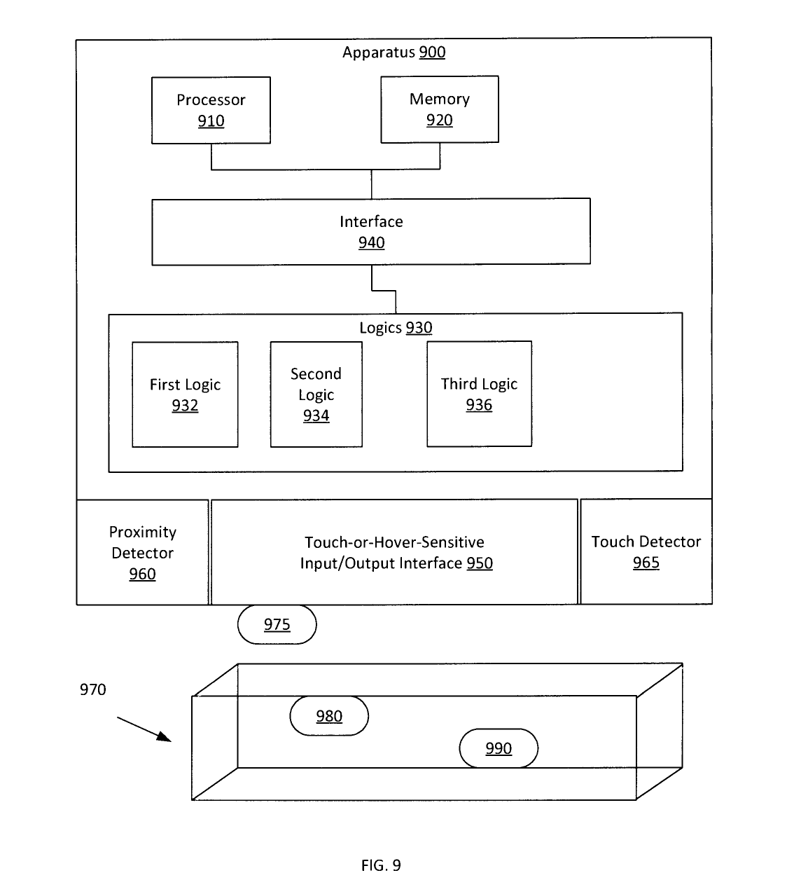

FIG. 9 illustrates an apparatus 900 that controls both itself and a secondary display. In one example, the apparatus 900 includes a physical interface 940 that connects a processor 910, a memory 920, a set of logics 930, a proximity detector 960, a touch detector 965, and a touch sensitive or hover sensitive i/o interface 950. The set of logics 930 may control what is displayed on the apparatus 900 and may control what is displayed on a secondary display associated with another apparatus. In one embodiment, the proximity detector 960 and the touch detector 965 may share a set of capacitive sensing nodes that provide both touch-sensitivity and hover-sensitivity for the input/output interface. Elements of the apparatus 900 may be configured to communicate with each other, but not all connections have been shown for clarity of illustration.

The touch detector 965 may detect when an object 975 touches the i/o interface 950. The proximity detector 960 may detect an object 980 in a hover space 970 associated with the apparatus 900. The hover space 970 may be, for example, a three dimensional volume disposed in proximity to the i/o interface 950 and in an area accessible to the proximity detector 960. The hover space 970 has finite bounds.

In one embodiment, apparatus 900 may provide a shared browsing experience for two or more viewers of the secondary display. The shared browsing experience may include providing a shareable cursor or a per-viewer cursor that may be responsive to user interface actions performed at mobile devices associated with the two or more viewers. For example, if a first viewer has a smart phone, then apparatus 900 may provide a cursor on the secondary display that can be controlled by the first viewer interacting with their smart phone. Additionally, if a second viewer has a tablet, then apparatus 900 may provide another cursor on the secondary display that can be controlled by the second viewer interacting with their tablet. Either the first viewer or the second viewer may be using apparatus 900.

Handling user inputs from user devices (e.g., smart phones, tablets) facilitates apparatus 900 promoting a heads-up experience for a user by coordinating what is displayed on a user's device and what is displayed on the secondary display. The output may be coordinated to facilitate establishing and maintaining visual focus on the secondary display.

Apparatus 900 may include a first logic 932 that provides content to be displayed on the secondary display. The content may be produced by an application running, at least partially, on the apparatus 900. The content may be, for example, output produced by an application (e.g., browser) running on the apparatus 900. The application may be, for example, a movie presentation application, a television presentation application, a productivity application (e.g., word processor, spread sheet), a video game, or other application that has content to be viewed. The application may run partially or completely on the apparatus 900. The application may run partially on apparatus 900 when, for example, some processing is performed on another apparatus or in the cloud.

Apparatus 900 may include a second logic 934 that provides a control element to be displayed on the secondary display. In one embodiment, the control element is not produced by the application but is produced by the second logic 934. In one embodiment, the control element is a cursor. When the control element is a cursor, the second logic 934 controls the location, movement, or appearance of the cursor in response to a touch or hover interaction with the input/output interface 950. In one embodiment, the second logic 934 determines an initial location for the cursor. The initial location may be independent of a location of a touch or hover point associated with the input/output interface 950. Other attributes of the cursor may also be determined by second logic 934.

There is a distinction between what is provided by the first logic 932 and the second logic 934. The additional material provided by the second logic 934 is not an application or content that is produced by the application. Consider a browser. The first logic 932 displays the browser on the secondary display. The second logic 934 may provide a cursor for navigating the browser. Now consider a video game. The “content” provided by the first logic 932 may be a game map, avatars, weapons, explosions, and other images associated with the game. The additional material provided by the second logic 934 may be, for example, control buttons, navigation tools, a cursor for interacting with the control buttons, or other images that are not part of the game, even though they may be involved in game play.

The second logic 934 may make a decision concerning where to initially position the cursor when a touch or hover point is established. Rather than place the cursor at a position corresponding to the touch or hover point as is done by conventional systems, the second logic 934 may seek to optimize the user experience by, for example, minimizing the distance a user may have to move the cursor to achieve an effect. Thus, the initial location may be independent of a location of the touch or hover point with respect to the input/output interface 950. Therefore, in one embodiment, the second logic 934 may determine an initial location for the position indicator based, for example, on the location of a user interface element. The initial location may be, for example, in the center of a secondary display, over or near a control that is most likely to be used, equidistant between two controls, or in other locations determined by the context rather than by the location of the touch or hover point in the hover space 970.

Apparatus 900 may include a third logic 936 that selectively controls the application or an appearance of the content displayed on the secondary display. The control may be based, at least in part, on a user interface action performed with the input/output interface 950. The user interface action is not performed in a vacuum, but rather is performed based, at least in part, on what is displayed on the secondary display. Thus, control exercised in response to the user interface action depends, at least in part, on a relationship between the control element displayed on the secondary display and the content displayed on the secondary display. For example, if a user taps their smart phone while the cursor is displayed over a button, then a mouse click event may be generated for the button.

Apparatus 900 may include a memory 920. Memory 920 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 920 may be configured to store user interface state information, characterization data, object data, or other data.

Apparatus 900 may include a processor 910. Processor 910 may be, for example, a signal processor, a microprocessor, an application specific integrated circuit (ASIC), or other control and processing logic circuitry for performing tasks including signal coding, data processing, input/output processing, power control, or other functions. Processor 910 may be configured to interact with logics 930 that provide touch or hover point control processing.

In one embodiment, the apparatus 900 may be a general purpose computer that has been transformed into a special purpose computer through the inclusion of the set of logics 930. The set of logics 930 may control what is displayed on both the secondary display and on the apparatus 900. Apparatus 900 may interact with other apparatus, processes, and services through, for example, a computer network.

### Aspects of Certain Embodiments

In one embodiment, a method is performed in a first device having a touch or hover interface and having a first display. The method includes detecting a second device having a second display, establishing a communication link with the second device, entering a controller mode, selectively displaying, on the first display, a first output associated with an application running on the first device, providing a second output to be displayed on the second display, where the second output is associated with the application, and using the touch or hover interface to interact with the second output as displayed on the second display. In one embodiment, using the touch or hover interface to interact with the second output comprises selectively controlling the application, the first output, or the second output based, at least in part, on a touch or hover action performed with the touch or hover interface, where the touch or hover action is related to the second output. The method may also include providing a third output to be displayed on the second display, where the third output is associated with controlling the application, and where the third output is movable on the second display in response to touch or hover actions performed with the touch or hover interface, and selectively controlling the application, the first output, the second output, or the third output based, at least in part, on a touch or hover action performed with the touch or hover interface, where the touch or hover action is related to the second output and the third output.

In another embodiment, an apparatus includes a processor, a memory, an input/output interface that is touch-sensitive or hover-sensitive, a set of logics that control what is displayed on the apparatus and that control what is displayed on a secondary display associated with another apparatus, and a physical interface to connect the processor, the memory, the input/output interface and the set of logics. The set of logics includes a first logic that provides content to be displayed on the secondary display, where the content is produced by an application running, at least partially, on the apparatus. The set of logics also includes a second logic that provides a control element to be displayed on the secondary display, where the control element is not produced by the application. The set of logics also includes a third logic that selectively controls the application or an appearance of the content displayed on the secondary display based, at least in part, on a user interface action performed with the input/output interface, where the user interface action depends, at least in part, on a relationship between the control element displayed on the secondary display and the content displayed on the secondary display.

In another embodiment, a system includes a first mobile device running a first application, a second mobile device, and an apparatus having a display that is external to and disjoint from the first mobile device and the second mobile device. The first mobile device controls images displayed on the first mobile device and the display, where the images are associated with the first application. The first mobile device provides a first movable cursor for the first mobile device and a second movable cursor for the second mobile device, where the first movable cursor is movable on the display in response to actions performed at the first movable device, and where the second movable cursor is movable on the display in response to actions performed at the second movable device. The first mobile device handles user inputs at the first mobile device related to the first cursor and the first application. The first mobile device handles user inputs at the second mobile device related to the second cursor and the first application.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method performed in a first device having a touch or hover interface and having a first display, the method comprising:
detecting a second device having a second display;
establishing a communication link with the second device;
entering a controller mode on the first device;
selectively displaying, on the first display, a first output associated with an application running on the first device;
providing a second output to be displayed on the second display, where the second output is associated with the application; and
using the touch or hover interface to interact with the second output as displayed on the second display.

2. The method of claim 1, where using the touch or hover interface to interact with the second output comprises selectively controlling the application, the first output, or the second output based, at least in part, on a touch or hover action performed with the touch or hover interface, where the touch or hover action is related to the second output.

3. The method of claim 1, comprising:
providing a third output to be displayed on the second display, where the third output is associated with controlling the application, and where the third output is movable on the second display in response to touch or hover actions performed with the touch or hover interface, and
selectively controlling the application, the first output, the second output, or the third output based, at least in part, on a touch or hover action performed with the touch or hover interface, where the touch or hover action is related to the second output and the third output.

4. The method of claim 3, where the first device is a mobile computing device.

5. The method of claim 4, where the second device is a television or computer.

6. The method of claim 5, where the application is a web browser.

7. The method of claim 5, where the touch or hover action is a tap, a double tap, or a tap and hold.

8. The method of claim 5, where the touch or hover action is a gesture.

9. The method of claim 5, where the third output is a cursor.

10. The method of claim 9, comprising identifying whether an attribute of the cursor will be independent of a location of a touch or hover point associated with the touch or hover interface.

11. The method of claim 1, where establishing the communication link includes establishing a wired link or a wireless link.

12. The method of claim 1, where the application is running on the first device or where the application is running on a third device.

13. An apparatus, comprising:
a processor;
a memory;
an input/output interface that is touch-sensitive or hover-sensitive;
a set of logics that control what is displayed on the apparatus and that control what is displayed on a secondary display associated with another apparatus, and
a physical interface to connect the processor, the memory, the input/output interface and the set of logics,
the set of logics comprising:
a first logic that provides content to be displayed on the secondary display, where the content is produced by an application running, at least partially, on the apparatus;
a second logic that provides a control element to be displayed on the secondary display, where the control element is not produced by the application; and
a third logic that selectively controls the application or an appearance of the content displayed on the secondary display based, at least in part, on a user interface action performed with the input/output interface, where the user interface action depends, at least in part, on a relationship between the control element displayed on the secondary display and the content displayed on the secondary display.

14. The apparatus of claim 13, where the control element is a cursor, and where the second logic controls the location, movement, or appearance of the cursor in response to a touch or hover interaction with the input/output interface.

15. The apparatus of claim 13, where the set of logics provide a shared browsing experience for two or more viewers of the secondary display by providing a shareable cursor or a per-viewer cursor that may be responsive to user interface actions performed at mobile devices associated with the two or more viewers.

16. The apparatus of claim 13, where the set of logics promote a heads-up experience for a user of the apparatus by coordinating what is displayed on the apparatus and what is displayed on the secondary display to facilitate establishing and maintaining visual focus on the secondary display.

17. The apparatus of claim 14, where the second logic determines an initial location for the cursor, where the initial location is independent of a location of a touch or hover point associated with the input/output interface.

18. A system, comprising:
a first mobile device running a first application;
a second mobile device; and
an apparatus having a display that is external to and disjoint from the first mobile device and the second mobile device;
where the first mobile device controls images displayed on the first mobile device and the display, where the images are associated with the first application,
where the first mobile device provides a first movable cursor for the first mobile device and a second movable cursor for the second mobile device, where the first movable cursor is movable on the display in response to actions performed at the first movable device, and where the second movable cursor is movable on the display in response to actions performed at the second movable device,
where the first mobile device handles user inputs at the first mobile device related to the first cursor and the first application, and
where the first mobile device handles user inputs at the second mobile device related to the second cursor and the first application.

19. The system of claim 18,
where the second mobile device runs a second application,
where the first mobile device controls images displayed on the display, where the images are associated with the first application or the second application,
where the first mobile device handles user inputs at the first mobile device related to the first cursor and the first application, and
where the first mobile device handles user inputs at the second mobile device related to the second cursor and the second application.

20. The system of claim 18,
where the second mobile device runs a second application,
where the first mobile device controls images associated with the first application displayed on the display,
where the second mobile device controls images associated with the second application displayed on the display,
where the first mobile device handles user inputs at the first mobile device related to the first cursor and the first application, and
where the second mobile device handles user inputs at the second mobile device related to the second cursor and the second application.
